(19) United States
(12) Patent Application Publication
(10) Pub. No.: US 2024/0173964 A1
(43) Pub. Date: May 30, 2024

(54) DRIVE BOARD, LIQUID JET HEAD, AND LIQUID JET RECORDING DEVICE

(71) Applicant: SII Printek Inc., Chiba-shi (JP)

(72) Inventors: Yasuhito Sekiya, Chiba-shi (JP); Kensuke Yoshida, Chiba-shi (JP); Toshiaki Watanabe, Chiba-shi (JP); Shunji Kawamoto, Chiba-shi (JP)

(21) Appl. No.: 18/386,336

(22) Filed: Nov. 2, 2023

(30) Foreign Application Priority Data
Nov. 29, 2022 (JP) 2022-190194

(51) Int. Cl. B41J 2/045

(52) U.S. Cl. CPC B41J 2/04541; B41J 2002/14491

(57) ABSTRACT

A drive board and so on capable of improving a printing quality are provided. The drive board according to an embodiment of the present disclosure is a board configured to output a drive signal to be applied to a liquid jet head having a plurality of nozzles, including at least one drive device which is mounted on a board surface, and which is configured to generate the drive signal configured to jet a liquid from the nozzles, and at least one constant-potential wiring line which extends along a longitudinal direction of the drive device in a mounting area of the drive device, and to which a predetermined constant potential is applied. The drive device includes a plurality of output terminals which is arranged at respective positions different from each other along the longitudinal direction, and which is configured to individually output the drive signal, and constant-potential terminals at three or more places which are arranged along the longitudinal direction, and which are electrically coupled to the constant-potential wiring line to which the same constant potential is applied.

### RELATED APPLICATIONS

This application claims priority to Japanese Patent application No. JP2022-190194, filed on Nov. 29, 2022, the entire content of which is incorporated herein by reference.

### BACKGROUND OF THE INVENTION

### 1. Field of the Invention

The present disclosure relates to a drive board, a liquid jet head, and a liquid jet recording device.

### 2. Description of the Related Art

Liquid jet recording devices equipped with liquid jet heads are used in a variety of fields, and a variety of types of liquid jet heads have been developed (see, e.g., JP4992447B).

In such a liquid jet head, in general, it is required to improve the print quality when performing printing.

It is desirable to provide a drive board, a liquid jet head, and a liquid jet recording device capable of improving the print quality.

### SUMMARY OF THE INVENTION

A drive board according to an embodiment of the present disclosure is a board configured to output a drive signal to be applied to a liquid jet head having a plurality of nozzles, including at least one drive device which is mounted on a board surface of the drive board, and which is configured to generate the drive signal configured to jet liquid from the nozzles, and at least one constant-potential wiring line which extends along a longitudinal direction of the drive device in a mounting area of the drive device, and to which a predetermined constant potential is applied. The drive device includes a plurality of output terminals which is arranged along the longitudinal direction, and which is configured to individually output the drive signal, and constant-potential terminals at three or more places which are arranged at respective positions different from each other along the longitudinal direction, and which are electrically coupled to the constant-potential wiring line to which the same constant potential is applied.

A liquid jet head according to an embodiment of the present disclosure includes the drive board according to the embodiment of the present disclosure, and a jet section which is configured to jet the liquid based on the drive signal output from the drive board, and which has a plurality of nozzles.

A liquid jet recording device according to an embodiment of the present disclosure includes the liquid jet head according to the embodiment of the present disclosure.

According to the drive board, the liquid jet head, and the liquid jet recording device related to an embodiment of the present disclosure, it becomes possible to improve the printing quality.

### BRIEF DESCRIPTION OF THE DRAWINGS

FIG. 1 is a block diagram showing an outline configuration example of a liquid jet recording device according to a first embodiment of the present disclosure.

FIG. 2 is a plan view schematically showing an outline configuration example of a liquid jet head shown in FIG. 1.

FIG. 3 is a block diagram schematically showing a detailed configuration example of a drive device shown in FIG. 2.

FIG. 4 is a plan view schematically showing an outline configuration example of a drive board shown in FIG. 2.

FIG. 5 is a diagram schematically showing a cross-sectional configuration example along the line V-V shown in FIG. 4.

FIG. 6 is a plan view schematically showing an outline configuration example of a drive board related to Modified Example 1-1.

FIG. 7 is a plan view schematically showing an outline configuration example of a drive board related to Modified Example 1-2.

FIG. 8 is a plan view schematically showing an outline configuration example of a drive board related to Modified Example 1-3.

FIG. 9 is a plan view schematically showing an outline configuration example of a liquid jet head according to a second embodiment.

FIG. 10 is a plan view schematically showing an outline configuration example of a drive board shown in FIG. 9.

FIG. 11 is a diagram schematically showing a cross-sectional configuration example along the line XI-XI shown in FIG. 10.

FIG. 12 is a plan view schematically showing an outline configuration example of a drive board related to Modified Example 2.

### DETAILED DESCRIPTION OF THE PREFERRED EMBODIMENTS

Some embodiments of the present disclosure will hereinafter be described in detail with reference to the drawings. It should be noted that the description will be presented in the following order:
1. First Embodiment (an example when adopting flip-chip mounting, and three or more ground terminals)
2. Modified Examples of First Embodiment
   Modified Example 1-1 (an example of the case of three or more power-supply terminals and three or more ground terminals)
   Modified Example 1-2 (an example when a plurality of power-supply wiring lines is disposed)
   Modified Example 1-3 (an example of the case of three or more power-supply terminals)
3. Second Embodiment (an example when adopting wire-bonding mounting, and three or more ground terminals)
4. Modified Example of Second Embodiment
   Modified Example 2 (an example of the case of three or more power-supply terminals and three or more ground terminals)
5. Other Modified Examples

### 1. First Embodiment

### [Outline Configuration of Printer 5]

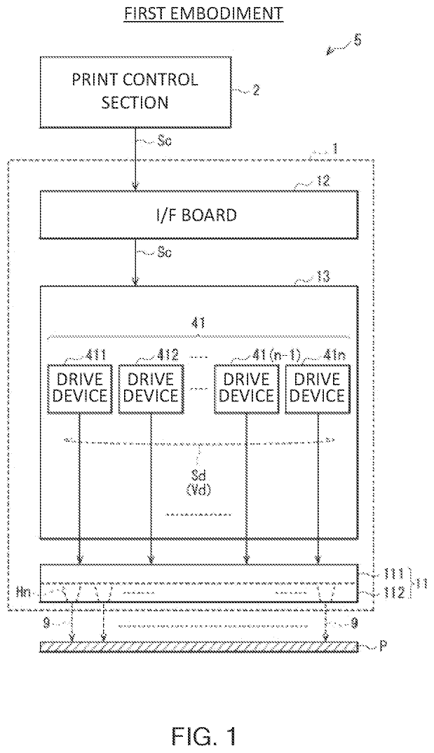

FIG. 1 is a block diagram showing an outline configuration example of a printer 5 as a liquid jet recording device according to a first embodiment of the present disclosure. It should be noted that a scale size of each of the members is accordingly altered so that the member is shown in a recognizable size in the drawings used in the description of the present specification.

The printer 5 is an inkjet printer for performing recording (printing) of images, characters, and the like on a recording target medium (e.g., recording paper P shown in FIG. 1) using ink 9 described later. As shown in FIG. 1, the printer 5 is mainly provided with an inkjet head 1 and a print control section 2.

It should be noted that the inkjet head 1 corresponds to a specific example of a “liquid jet head” in the present disclosure, and the printer 5 corresponds to a specific example of a “liquid jet recording device” in the present disclosure. Further, the ink 9 corresponds to a specific example of a “liquid” in the present disclosure.

### A. Print Control Section 2

The print control section 2 is for supplying the inkjet head 1 with a variety of types of information (data). Specifically, as shown in FIG. 1, the print control section 2 is arranged to supply each of constituents (drive devices 41 described later and so on) in the inkjet head 1 with a print control signal Sc.

It should be noted that the print control signal Sc is arranged to include, for example, image data, an ejection timing signal, and a power-supply voltage for making the inkjet head 1 operate.

### B. Inkjet Head 1

The inkjet head 1 is a head for jetting (ejecting) the ink 9 shaped like a droplet from a plurality of nozzle holes Hn described later to the recording paper P as represented by dotted arrows in FIG. 1 to thereby perform recording of images, characters, and so on. As shown in FIG. 1, the inkjet head 1 is provided with a single jet section 11, a single I/F (interface) board 12, and a single drive board 13.

### B-1. Jet Section 11

As shown in FIG. 1, the jet section 11 is a part which has the plurality of nozzle holes Hn, and which jets the ink 9 from these nozzle holes Hn. Such jet of the ink 9 is arranged to be performed (see FIG. 1) based on drive signals Sd (drive voltages Vd) output from the drive devices 41 described later on the drive board 13.

As shown in FIG. 1, such a jet section 11 is configured to include an actuator plate 111 and a nozzle plate 112. It should be noted that it is arranged that the ink 9 is supplied to the jet section 11 (the actuator plate 111) from, for example, an ink tank (not shown in FIG. 1) in the printer 5 via an ink supply tube.

### (Nozzle Plate 112)

The nozzle plate 112 is a plate formed of a film material such as polyimide, or a metal material, and has the plurality of nozzle holes Hn described above as shown in FIG. 1. These nozzle holes Hn are formed side by side at predetermined intervals, and each have, for example, a circular shape. It should be noted that such two or more nozzle holes Hn each correspond to a specific example of a “nozzle” in the present disclosure.

### (Actuator Plate 111)

The actuator plate 111 is a plate formed of a piezoelectric material such as PZT (lead zirconate titanate). It should be noted that the actuator formed of such a plate (shaped like such a plate) is not a limitation, and it is possible to adopt an actuator having other shapes. The actuator plate 111 is provided with a plurality of channels (pressure chambers). These channels are each a part for applying pressure to the ink 9, and are arranged side by side so as to be parallel to each other at predetermined intervals. Each of the channels is partitioned with drive walls (not shown) formed of a piezoelectric body, and forms a groove part having a recessed shape in a cross-sectional view.

As such channels, there exist ejection channels for ejecting the ink 9, and dummy channels (non-ejection channels) which do not eject the ink 9. In other words, it is arranged that the ejection channels are filled with the ink 9 on the one hand, but the dummy channels are not filled with the ink 9 on the other hand. It should be noted that it is arranged that filling of each of the ejection channels with the ink 9 is performed via, for example, a flow channel (a common flow channel) commonly communicated with such ejection channels. Further, it is arranged that each of the ejection channels is individually communicated with the nozzle hole Hn in the nozzle plate 112 on the one hand, but each of the dummy channels is not communicated with the nozzle hole Hn on the other hand. The ejection channels and the dummy channels are alternately arranged side by side along a predetermined direction.

Further, on the inner side surfaces opposed to each other in the drive wall described above, there are respectively disposed drive electrodes. As the drive electrodes, there exist common electrodes disposed on the inner side surfaces facing the ejection channels, and active electrodes (individual electrodes) disposed on the inner side surfaces facing the dummy channels. These drive electrodes and drive devices 41 described later are electrically coupled to each other via the drive board 13. Thus, it is arranged that the drive voltages Vd (the drive signals Sd) described above are applied from the drive devices 41 to the active electrodes via the drive board 13 (see FIG. 1). It should be noted that it is arranged that a ground potential Vg described later is applied to each of the common electrodes.

### B-2. I/F Board 12

As shown in FIG. 1, the I/F board 12 is a board (a relay board) intervening between the drive board 13 and an outside (the print control section 2) of the inkjet head 1. Thus, it is arranged that the print control signal Sc input from the print control section 2 is supplied to the drive board 13 (the drive devices 41 and so on) via the I/F board 12.

### B-3. Drive Board 13

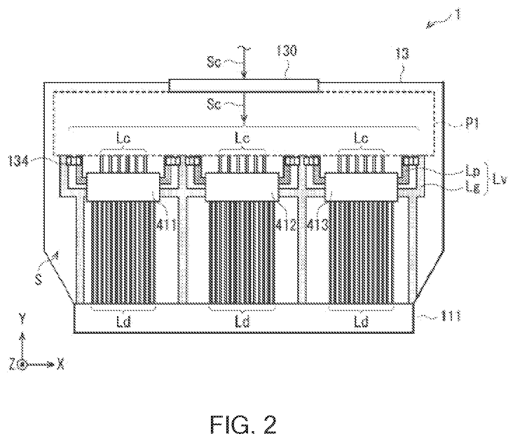

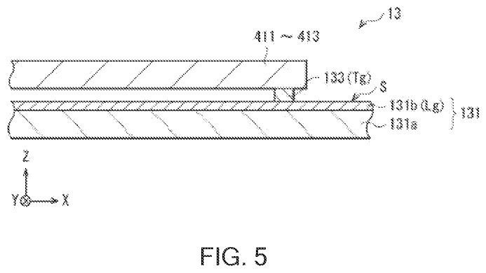

As shown in FIG. 1, the drive board 13 is a board for electrically coupling the I/F board 12 and the jet section 11 to each other. Although the details will be described later (see FIG. 5), the drive board 13 is configured using a flexible board 131 using polyimide as a base film 131a. It should be noted that the drive board 13 and the I/F board 12 are electrically coupled to each other via a connector 130 (see FIG. 2). It is arranged that this drive board 13 outputs the drive signals Sd described above from the drive devices 41 to thereby individually control the jet operation of the ink 9 in the nozzle plate 112 described above.

As shown in FIG. 1, such a drive board 13 is provided with the plurality of drive devices 41. Specifically, in the example shown in FIG. 1, n drive devices 41 consisting of drive devices 411, 412, ⋅ ⋅ ⋅ , 41(n−1), 41n (n: an integer no smaller than 2) are disposed on the drive board 13.

As shown in FIG. 1, these drive devices 41 are each a device for generating the drive signals Sd (the drive voltages Vd) described above for jetting the ink 9 from the nozzle holes Hn in the jet section 11 based on the print control signal Sc input from the I/F board 12, and then outputting the drive signals Sd thus generated to the jet section 11. Such drive devices 41 are each formed of, for example, an ASIC (Application Specific Integrated Circuit).

### [Detailed Configuration of Inkjet Head 1]

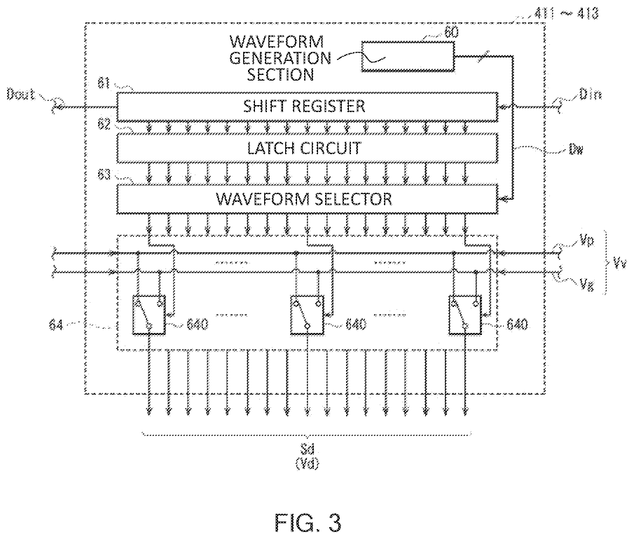

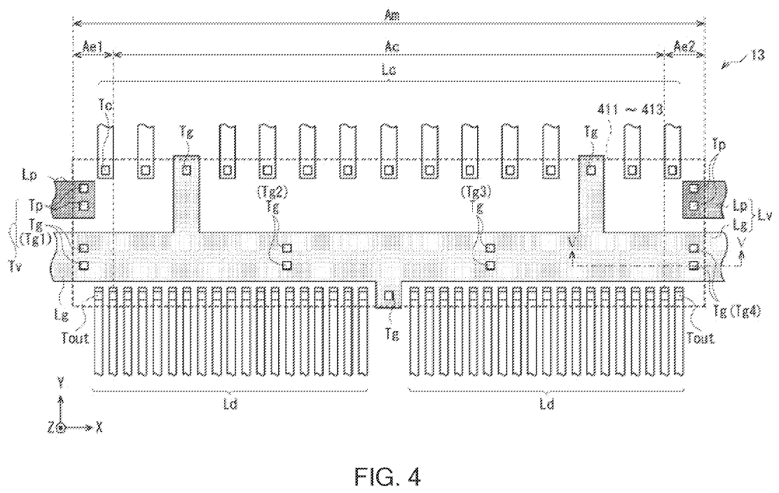

Then, a detailed configuration example of the inkjet head 1 will be described with reference to FIG. 2 through FIG. 5. FIG. 2 is a plan view (an X-Y plane view) schematically showing an outline configuration example of the inkjet head 1 shown in FIG. 1. It should be noted that in FIG. 2, the illustration of a structure is omitted, and only an electrical circuit and the actuator plate 111 are shown. Further, in an area (an area between the connector 130 described above and a decoupling capacitor 134 described later) denoted by the reference symbol P1 in FIG. 2, the illustration of a variety of wiring lines is omitted for the sake of convenience. FIG. 3 is a block diagram schematically showing a detailed configuration example of each of the drive devices 41 (the drive devices 411 through 413 described later) shown in FIG. 2. FIG. 4 is a plan view (an X-Y plane view) schematically showing an outline configuration example (a configuration example in the vicinity of each of the drive devices 411 through 413) of the drive board 13 shown in FIG. 2. FIG. 5 is a diagram schematically showing a cross-sectional configuration example (a Z-X cross-sectional configuration example) along the line V-V shown in FIG. 4.

### (Plane Configuration/Cross-Sectional Configuration of Drive Board 13)

First, as shown in FIG. 2, on a board surface S (the X-Y plane) of the drive board 13, there is arranged the plurality of drive devices 41 (the three drive devices 411 through 413 in the example shown in FIG. 2) side by side along a longitudinal direction (the X-axis direction) of the drive device 41. It should be noted that the expression “arranged side by side along a longitudinal direction” is not limited to a linear arrangement (along the X-axis direction), and it is possible to adopt an arrangement with some displacement such as a staggered arrangement (a zigzag arrangement) along the Y-axis direction.

Further, on the board surface S of the drive board 13, there are arranged the variety of wiring lines in a patterned manner. Specifically, as shown in FIG. 2, on the board surface S of the drive board 13, there are arranged predetermined constant-potential wiring lines Lv. As the constant-potential wiring lines Lv, there are included power-supply wiring lines Lp to which a power-supply potential Vp described later as a constant potential is applied, and a ground wiring line Lg to which the ground potential Vg described later as a constant potential is applied. The power-supply wiring lines Lp are electrically coupled individually to the respective drive devices 41 in the example shown in FIG. 2, and the ground wiring line Lg is electrically coupled commonly to the plurality of drive devices 41 in the example shown in FIG. 2. It should be noted that a detailed configuration example of these constant-potential wiring lines Lv (the power-supply wiring lines Lp and the ground wiring line Lg) will be described later (FIG. 4).

Further, as shown in FIG. 5, the drive board 13 is configured using the flexible board 131 in which a wiring layer 131b is arranged on the base film 131a. In the first embodiment, the drive devices 41 (411 through 413) are mounted on the board surface S in the flexible board 131 using the flip-chip mounting. Specifically, in the example of the drive board 13 shown in FIG. 5, the drive devices 411 through 413 and the wiring layer 131b (the ground wiring line Lg in the example shown in FIG. 5) on the board surface S in the flexible board 131 are electrically coupled to each other via bumps 133 (corresponding to ground terminals Tg) arranged at a reverse surface side of the drive devices 411 through 413.

Here, as shown in FIG. 2, on the board surface S of the drive board 13, there are arranged the decoupling capacitors 134 between the power-supply wiring lines Lp and the ground wiring line Lg arranged so as to be adjacent to each other. Specifically, such decoupling capacitors 134 are arranged in the vicinity of power-supply input terminals (constant-potential terminals Tv described later) in each of the drive devices 41. It is arranged that problems of a wiring impedance (a voltage variation, noise generation, an operation error, and so on) caused by a long wiring distance in the upstream side (the power-supply circuit side) of the decoupling capacitors 134 are solved by arranging such decoupling capacitors 134. It should be noted that in the downstream side (a side of the drive devices 411 through 413) of the decoupling capacitors 134, the problems (described later in detail) of the wiring impedance caused by the long wiring distance cannot be solved by the decoupling capacitors 134.

### (Block Configuration of Drive Devices 41)

Then, a block configuration example of the drive devices 41 (the drive devices 411 through 413 described above) will be described with reference to FIG. 3.

As shown in FIG. 3, the drive devices 41 each have a waveform generation section 60, a shift register 61, a latch circuit 62, a waveform selector 63, and a switch section 64.

The waveform generation section 60 is for generating waveform data Dw to be used when generating the drive signals Sd. The waveform data Dw generated by the waveform generation section 60 in such a manner is arranged to be output to the waveform selector 63.

The shift register 61 is a circuit for inputting the image data for the plurality of nozzle holes Hn as input data Din, and at the same time, sequentially transmitting the image data from an anterior stage side toward a posterior stage in accordance with the drive signals Sd for the plurality of nozzle holes Hn, and then holding the result. The shift register 61 has the same number of FF (flip-flop) circuits as the number of the corresponding nozzle holes Hn. It should be noted that it is arranged that the image data for the plurality of nozzle holes Hn described above is also output from the shift register 61 as output data Dout.

The latch circuit 62 is a circuit for holding the image data for the plurality of nozzle holes Hn output from the FF circuits in the shift register 61 in sync with a predetermined ejection timing signal. The latch circuit 62 has the same number of latch circuits as the number of the corresponding nozzle holes Hn.

The waveform selector 63 is a circuit for generating control signals (switch control signals) to switches 640 described later based on the image data for the plurality of nozzle holes Hn output from the latch circuits in the latch circuit 62, the ejection timing signal described above, and the waveform data Dw output from the waveform generation section 60. The waveform selector 63 has the same number of waveform selection circuits as the number of the corresponding nozzle holes Hn, and is arranged to generate the switch control signals for the plurality of nozzle holes Hn in the waveform selection circuits.

The switch section 64 is a circuit for generating the drive signals Sd for the plurality of nozzle holes Hn based on the switch control signals for the plurality of nozzle holes Hn output from the waveform selection circuits in the waveform selector 63. The switch section 64 has the same number of switches 640 as the number of the corresponding nozzle holes Hn. Further, the switches 640 are arranged to respectively generate the drive signals Sd having the drive voltages Vd corresponding respectively to the nozzle holes Hn by performing conversion of signal levels (voltage values) based on the switch control signal described above, and predetermined constant potentials Vv (the power-supply potential Vp and the ground potential Vg; see FIG. 3).

### (Plane Configuration of Drive Devices 41)

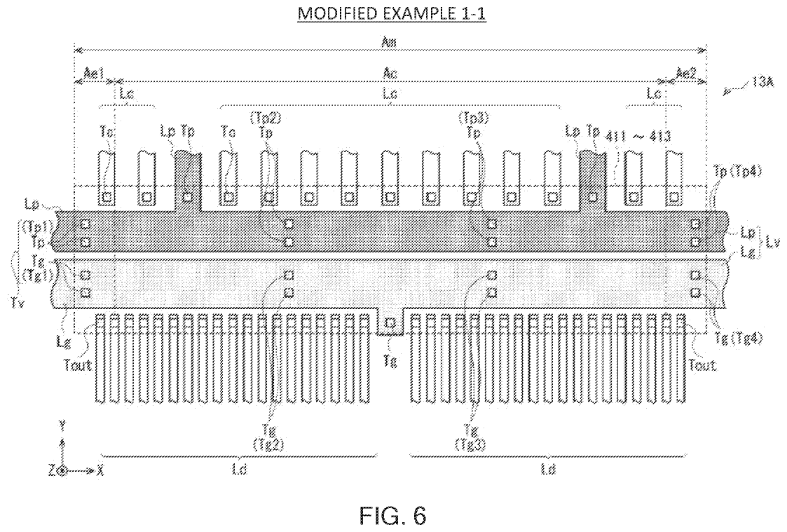

Then, a plane configuration example (an X-Y plane configuration example) in the vicinity of the drive devices 41 (411 through 413) in the drive board 13 of the first embodiment will be described in detail with reference to FIG. 4. It should be noted that in FIG. 4, the variety of terminals located at the reverse surface side (the flexible board 131 side in the example shown in FIG. 4) of the drive devices 41 and the variety of wiring lines on the flexible board 131 are each represented by solid lines for the sake of convenience, and the drive devices 41 are represented by dotted lines as the outer shapes thereof for the sake of convenience. This point also applies to Modified Examples 1-1 through 1-3 (FIG. 6 through FIG. 8) described later.

As shown in FIG. 4, at the reverse surface side of the drive devices 41 (411 through 413), there are disposed a plurality of control terminals Tc, a plurality of the constant-potential terminals Tv, and a plurality of output terminals Tout in a mounting area Am (to the board surface S) of each of the drive devices 42. Further, on the reverse surface side of the drive devices 41, the single constant-potential wiring line Lv or the plurality of constant-potential wiring lines Lv to which the predetermined constant potential Vv (the power-supply potential Vp or the ground potential Vg) described above is applied extend along a longitudinal direction (the X-axis direction) of each of the drive devices 41 in the mounting area Am of each of the drive devices 41. Specifically, in the example shown in FIG. 4, the single power-supply wiring line Lp to which the power-supply potential Vp is applied and the single ground wiring line Lg to which the ground potential Vg is applied are disposed as such constant-potential wiring lines Lv. It should be noted that the power-supply wiring line Lp extends from an outside of each of the drive devices 41 to a pair of end portions along the longitudinal direction, but does not extend to an inside (a central area Ac side described later) along the longitudinal direction beyond each of the end portions.

The plurality of control terminals Tc is electrically coupled individually to a plurality of control wiring lines Lc through which the image data, the ejection timing signal, and logic power supply out of elements (the image data, the ejection timing signal, the power-supply voltage, and so on) included in the print control signals Sc described above are respectively transmitted. The plurality of control terminals Tc is arranged side by side along the longitudinal direction (the X-axis direction) of each of the drive devices 41 at a connector 130 side in a direction (the Y-axis direction) along a shorter dimension of each of the drive devices 41. Further, the plurality of output terminals Tout is electrically coupled individually to a plurality of drive wiring lines Ld through which the drive signals Sd described above are transmitted, and is arranged side by side along the longitudinal direction (the X-axis direction) of each of the drive devices 41 at an actuator plate 111 side in the direction (the Y-axis direction) along the short dimension of each of the drive devices 41.

In the example shown in FIG. 4, the plurality of constant-potential terminals Tv has power-supply terminals Tp to electrically be coupled to the power-supply wiring line Lp described above, and the ground terminals Tg to electrically be coupled to the ground wiring line Lg described above. In other words, a driving power supply (the power-supply potential Vp) and a driving ground (the ground potential Vg) out of the elements described above included in the print control signals Sd are electrically coupled individually to the power-supply terminals Tp and the ground terminals Tg via the power-supply wiring lines Lp and the ground wiring lines Lg, respectively. In the example shown in FIG. 4, the plurality of power-supply terminals Tp and the plurality of ground terminals Tg are each arranged side by side along the direction (the Y-axis direction) along the shorter dimension of each of the drive devices 41 in the pair of (left and right) end portions along the longitudinal direction (the X-axis direction) of each of the drive devices 41. Further, in the example shown in FIG. 4, the plurality of ground terminals Tg is arranged along the longitudinal direction of each of the drive devices 41 in at least one (both of the connector 130 side and the actuator plate 111 side in the example shown in FIG. 4) of the connector 130 side and the actuator plate 111 side in the direction along the shorter dimension in each of the drive devices 41.

Here, in the drive board 13 shown in FIG. 4, each of the drive devices 41 is provided with the constant-potential terminals Tv at three or more places which are arranged at respective positions different from each other along the longitudinal direction (the X-axis direction) of each of the drive devices 41, and which are electrically coupled to the constant-potential wiring lines Lv to which the same constant potential Vv is applied. Specifically, in the example shown in FIG. 4, the ground terminals Tg at three or more places electrically coupled to the ground wiring line Lg are arranged at respective positions different from each other along the longitudinal direction of each of the drive devices 41. In contrast, in the example shown in FIG. 4, the power-supply terminals Tp are electrically coupled to the power-supply wiring lines Lp only in the pair of end portions (the two power-supply terminals Tp for each) along the longitudinal direction of each of the drive devices 41.

More specifically, when assuming that a pair of end-portion areas Ae1, Ae2 and a central area Ac located between those end-portion areas Ae1, Se2 are disposed along the longitudinal direction in each of the drive devices 41 (see FIG. 4), the following is arranged in the drive board 13 shown in FIG. 4. It should be noted that each of such end-portion areas Ae1, Ae2 means an area having a length in a range of about (0.01×Lx through 0.1×Lx) from an outer edge along the longitudinal direction of each of the drive devices 41 with reference to the length (an X-axis direction length Lx) along the longitudinal direction of each of the drive devices 41 as an example.

In the example shown in FIG. 4, in each of the pair of end-portion areas Ae1, Ae2 and the central area Ac, there are arranged the ground terminals Tg at three or more places as the constant-potential terminals at three or more places described above. Further, in particular in the example shown in FIG. 4, the plurality of ground terminals Tg as the plurality of constant-potential terminals Tv is arranged in the central area Ac. It should be noted that when, for example, only a single constant-potential terminal (the single ground terminal Tg in the example shown in FIG. 4) is disposed in the central area Ac, the constant-potential terminal can be arranged in, for example, either of the end portion (at the connector 130 side or the actuator plate 111 side) and the central portion along the direction (the Y-axis direction) along the shorter dimension of the drive device 41. Further, in the example shown in FIG. 4, these constant-potential terminals Tv at three or more places (the ground terminals Tg at three or more places) are evenly arranged along the longitudinal direction (the X-axis direction) of each of the drive devices 41. Specifically, in this example shown in FIG. 4, ground terminals Tg1, Tg2, Tg3, and Tg4 at four places are evenly arranged in each of the drive devices 41 along the X-axis direction.

Here, the power-supply potential Vp and the ground potential Vg described above each correspond to one specific example of the “predetermined constant potential” in the present disclosure, and the power-supply wiring line Lp and the ground wiring line Lg described above each correspond to one specific example of the “constant-potential wiring line” in the present disclosure. Further, in the first embodiment, the ground terminals Tg (the terminals electrically coupled to the ground wiring line Lg to which the same ground potential Vg is applied) at three or more places described above correspond to one specific example of the “constant-potential terminals at three or more places” in the present disclosure.

### [Operations and Functions/Advantages]

### A. Basic Operation of Printer 5

In the printer 5, a recording operation (a printing operation) of images, characters, and so on to the recording target medium (the recording paper P and so on) is performed using such a jet operation of the ink 9 by the inkjet head 1 as described below. Specifically, in this inkjet head 1, the jet operation of the ink 9 using a shear mode is performed in the following manner.

First, in the printer 5, a carriage equipped with the inkjet head 1 starts a reciprocal motion on the recording paper P. Then, each of the drive devices 41 on the drive board 13 applies the drive voltages Vd (the drive signals Sd) to the active electrodes described above in the actuator plate 111 in the jet section 11 based on the print control signal Sc supplied from the print control section 2 via the I/F board 12. Specifically, each of the drive devices 41 applies the drive voltage Vd to the active electrode arranged on the pair of drive walls partitioning the ejection channel described above. Thus, the pair of drive walls each deform so as to protrude toward the dummy channel adjacent to the ejection channel.

On this occasion, it results in that the drive wall makes a flexion deformation centering on the intermediate position in the depth direction in the drive wall. Further, due to such a flexion deformation of the drive wall, the ejection channel deforms as if the ejection channel bulges. As described above, due to the flexion deformation caused by a piezoelectric thickness-shear effect in the pair of drive walls, the volume of the ejection channel increases. Further, by the volume of the ejection channel increasing, the ink 9 which has been supplied from the ink tank described above into the actuator plate 111 is induced into the ejection channel as a result.

Subsequently, the ink 9 induced into the ejection channel in such a manner turns to a pressure wave to propagate to the inside of the ejection channel. Then, the drive voltage Vd to be applied to the drive electrodes becomes 0 (zero) V at the timing at which the pressure wave has reached the nozzle hole Hn of the nozzle plate 112 (or timing around that timing). Thus, the drive walls are restored from the state of the flexion deformation described above, and as a result, the volume of the ejection channel having once increased is restored again.

In such a manner, the pressure inside the ejection channel increases in the process that the volume of the ejection channel is restored, and thus, the ink 9 in the ejection channel is pressurized. As a result, the ink 9 shaped like a droplet is ejected (see FIG. 1) toward the outside (toward the recording paper P) through the nozzle hole Hn. The jet operation (the ejection operation) of the ink 9 in the inkjet head 1 is performed in such a manner, and as a result, the recording operation of images, characters, and so on to the recording paper P is performed.

### B. Functions/Advantages

Then, functions and advantages of the first embodiment will be described in detail.

### B-1. Regarding Related-Art Inkjet Head

First, in the inkjet head having a plurality of nozzle holes, in general, there is a demand to increase the number of outputs covered by each drive device (driver IC (Integrated Circuit)) in accordance with an increase in the number of nozzles.

It should be noted that when attempting to increase the output terminals, it results in an increase in the length in the longitudinal direction in the drive device, and therefore, the wiring distance in the longitudinal direction of the power-supply wiring line and the ground wiring line in the drive device increases, and thus, it becomes difficult to homogenize the wiring impedance between the output terminals. Further, when the number of the outputs increases, it results in that the total power-supply current also increases, and thus, it results in that a difference between the outputs is further increased. It should be noted that although the impedance of the wiring line can be decreased by, for example, increasing the width of the wiring line in the drive device, in that case, the area of the wiring line increases, which leads to an increase in cost of the drive board and the inkjet head.

In this way, in the related-art inkjet head (e.g., when the constant-potential terminals Tv described above are disposed at two or less places along the longitudinal direction in the drive device; a comparative example), a variation in impedance of the wiring line between the output terminals increases, and a variation (e.g., a level of ringing, and rising speed and falling speed of the drive waveform) in the drive waveform between the drive signals output from the respective output terminals also increases. Therefore, in such a comparative example, the variation in ejection characteristics of the ink from the nozzle holes also increases, and as a result, there is a possibility that the print quality when performing printing using the inkjet head degrades.

### B-2. Functions/Advantages

Therefore, in the inkjet head 1 according to the first embodiment, as described above, the following configuration is adopted.

First, in the inkjet head 1, the constant-potential terminals Tv at three or more places described above (the ground terminals Tg at three or more places) are disposed at respective positions different from each other along the longitudinal direction (the X-axis direction) of the drive device 41 in the drive board 13. Further, the constant-potential terminals Tv at three or more places (the ground terminals Tg at three or more places) are electrically coupled to the constant-potential wiring lines Lv (the ground wiring lines Lg) to which the same constant potential Vv (the ground potential Vg) is applied.

Thus, in the first embodiment, the following is arranged compared to the case of, for example, the comparative example described above. That is, a wiring distance (a wiring distance in each of the drive devices 41) from each of the constant-potential terminals Tv (each of the ground terminals Tg) inside the drive device 41 to each of the output terminals Tout (arranged along the longitudinal direction described above) shortens. Further, since the wiring line from the decoupling capacitor 134 to each of the constant-potential terminals Tv (each of the ground terminals Tg) can be coupled with a thick wiring line on the flexible board 131, the wiring line inside the drive device 41 is reinforced, and it results in that the impedance of the wiring line decreases. Thus, since the variation in impedance between the output terminals Tout is suppressed, and the variation in drive waveform between the drive signals Sd output from the respective output terminals Tout is also suppressed, the variation in ejection characteristics of the ink 9 from the nozzle holes Hn is also suppressed. As a result, in the first embodiment, it becomes possible to improve the printing quality when performing printing using the inkjet head 1 compared to the case of the comparative example described above and so on.

Further, in particular in the first embodiment, since the power-supply wiring lines Lp and the ground wiring lines Lg are included as the constant-potential wiring lines Lv described above, and at the same time, the ground terminals Tg at three or more places are disposed as the constant-potential terminals Tv at three or more places as described above, the following is arranged. That is, also when including such a variety of wiring lines as the constant-potential wiring lines Lv, the wiring distance from each of the constant-potential terminals Tv (the ground terminals Tg) to the corresponding one of the output terminals Tout shortens. Further, as a result the variation in impedance of the wiring lines (the ground wiring lines Lg) between the output terminals Tout is further suppressed, the variation in the ejection characteristics of the ink 9 from the nozzle holes Hn is further suppressed. As a result, it becomes possible to further improve the printing quality when performing printing using the inkjet head 1.

Further, in the first embodiment described above, the constant-potential terminals Tv (the ground terminals Tg) described above are arranged in each of the pair of end-portion areas Ae1, Ae2 and the central area Ac in the drive board 13. Thus, the following is arranged compared to when, for example, the constant-potential terminals Tv at three or more places described above (the ground terminals Tg at three or more places) are unevenly arranged along the longitudinal direction of the drive device 41. In other words, the wiring distance described above inside the drive device 41 further shortens in average, and at the same time, the variation in impedance between the output terminals Tout described above is further suppressed, as a result, the variation in ejection characteristics of the ink 9 from the nozzle holes Hn is also further suppressed. As a result, it becomes possible to further improve the printing quality when performing printing using the inkjet head 1.

Further, in the first embodiment described above, since the plurality of constant-potential terminals Tv (the plurality of ground terminals Tg) is arranged inside the central area Ac described above, the following is arranged compared to when, for example, only a single constant-potential terminal Tv (the ground terminal Tg) is arranged inside the central area Ac. In other words, the wiring distance described above inside the drive device 41 further shortens in average, and at the same time, the variation in impedance between the output terminals Tout described above is further more suppressed, as a result, the variation in ejection characteristics of the ink 9 from the nozzle holes Hn is also further more suppressed. As a result, it becomes possible to further more improve the printing quality when performing printing using the inkjet head 1.

In addition, in the first embodiment described above, the constant-potential terminals Tv at three or more places described above (the ground terminals Tg1 through Tg4 described above in the example shown in FIG. 4) are evenly arranged along the longitudinal direction of the drive device 41. Thus, the following is arranged compared to when, for example, the constant-potential terminals Tv at three or more places are unequally (unevenly) arranged along the longitudinal direction of the drive device 41. In other words, the wiring distance described above inside the drive device 41 further shortens in average, and at the same time, the variation in impedance between the output terminals Tout described above is further suppressed, as a result, the variation in ejection characteristics of the ink 9 from the nozzle holes Hn is also further suppressed. As a result, it becomes possible to further improve the printing quality when performing printing using the inkjet head 1.

Further, in the first embodiment described above, the drive devices 41 are mounted on the board surface S using the flip-chip mounting. Thus, in the first embodiment, the following is arranged compared to when, for example, the drive devices 41 are mounted on the board surface S using wire-bonding mounting (in the case of the second embodiment and Modified Example 2 described later, for example). That is, unlike the case of such wire-bonding mounting, it is possible to arrange the constant-potential terminals Tv not only in an area of an outer circumferential edge of the drive device 41 but also in an inside area. Therefore, it becomes possible to enhance the degree of freedom of an arrangement of the constant-potential terminals Tv, and at the same time, a space for coupling a lead wire 135 described later also, or the like becomes unnecessary, and therefore, it becomes possible to achieve a reduction in size of the drive board 13.

In addition, in the first embodiment described above, since the plurality of drive devices 41 is arranged side by side along the longitudinal direction on the board surface S, the paths of the wiring patterns (e.g., the wiring patterns such as the constant-potential wiring lines Lv) on the board surface S become short, or simplified. As a result, it becomes possible to achieve the reduction in size of the drive board 13.

### 2. Modified Examples of First Embodiment

Then, some modified examples (Modified Examples 1-1, 1-2, and 1-3) of the first embodiment described above will be described. It should be noted that hereinafter, the same constituents as those in the first embodiment are denoted by the same reference symbols, and the description thereof will arbitrarily be omitted.

### Modified Example 1-1

### (Configuration)

FIG. 6 is a plan view (an X-Y plane view) schematically showing an outline configuration example (a configuration example in the vicinity of each of the drive devices 41) of a drive board (a drive board 13A) related to Modified Example 1-1. The drive board 13A related to Modified Example 1-1 corresponds to what is obtained by changing the arrangement configuration of the power-supply wiring lines Lp and the power-supply terminals Tp in the drive board 13 (see FIG. 4) related to the first embodiment, and the rest of the configuration is made basically the same.

Specifically, as shown in FIG. 6, in the drive board 13A, first, both of the power-supply wiring lines Lp and the ground wiring lines Lg extend along the longitudinal direction (the X-axis direction) of each of the drive devices 41 in the mounting area Am of each of the drive devices 41 unlike the drive board 13 (FIG. 4) in the first embodiment. Further, in the example shown in FIG. 6, both of the power-supply terminals Tp at three or more places electrically coupled to the power-supply wiring line Lp and the ground terminals Tg at three or more places electrically coupled to the ground wiring line Lg are arranged at respective positions different from each other along the longitudinal direction of each of the drive devices 41. Specifically, in the example shown in FIG. 6, in each of the pair of end-portion areas Ae1, Ae2 and the central area Ac in the drive board 13A, there are each arranged such power-supply terminals Tp at three or more places, and the ground terminals Tg at three or more places. Further, in the example shown in FIG. 6, the plurality of power-supply terminals Tp and the plurality of ground terminals Tg are each arranged in the central area Ac. Further, in the example shown in FIG. 6, the power-supply terminals Tp at three or more places described above and the ground terminals Tg at three or more places are each evenly arranged along the longitudinal direction of each of the drive devices 41. Specifically, in this example shown in FIG. 6, power-supply terminals Tp1, Tp2, Tp3, and Tp4 at four places and the ground terminals Tg1, Tg2, Tg3, and Tg4 at four places are each evenly arranged in each of the drive devices 41 along the X-axis direction.

Here, in Modified Example 1-1 described above, the power-supply terminals Tp at three or more places described above (the terminals electrically coupled to the power-supply wiring line Lp to which the same power-supply potential Vp is applied), and the ground terminals Tg at three or more places each correspond to one specific example of the “constant-potential terminals at three or more places” in the present disclosure.

### Functions/Advantages

Also in Modified Example 1-1 having such a configuration, it becomes possible to obtain substantially the same advantages due to basically the same functions as those of the first embodiment.

Further, in particular in Modified Example 1-1 described above, since both of the power-supply terminals Tp at three or more places and the ground terminals Tg at three or more places are disposed as the constant-potential terminals Tv at three or more places described above in the drive board 13A, the following is arranged. That is, the wiring distance (the wiring distance inside each of the drive devices 41) from each of the constant-potential terminals Tv (the power-supply terminals Tp and the ground terminals Tg) to corresponding one of the output terminals Tout shortens. Further, the variation in impedance of the wiring lines (the power-supply wiring lines Lp and the ground wiring lines Lg) between the output terminals Tout is further suppressed, as a result, the variation in the ejection characteristics of the ink 9 from the nozzle holes Hn is further suppressed. As a result, it becomes possible to further improve the printing quality when performing printing.

### Modified Example 1-2

### (Configuration)

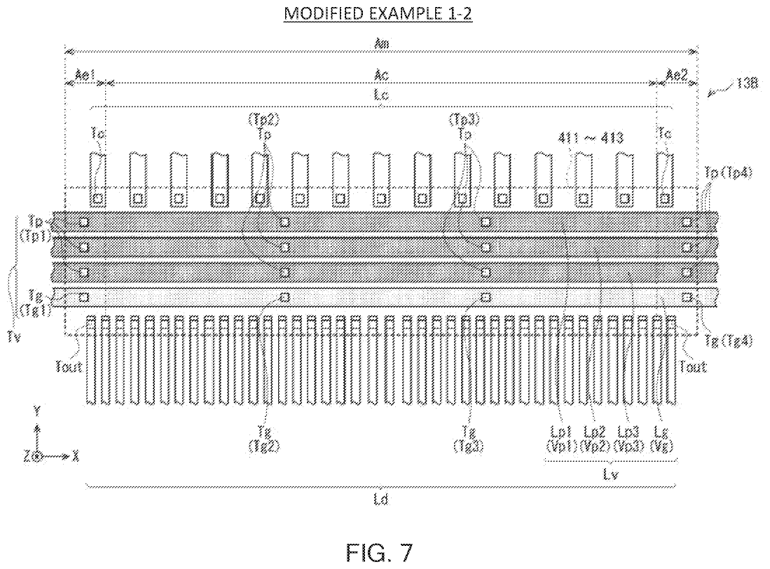

FIG. 7 is a plan view (an X-Y plane view) schematically showing an outline configuration example (a configuration example in the vicinity of each of the drive devices 41) of a drive board (a drive board 13B) related to Modified Example 1-2. The drive board 13B in Modified Example 1-2 corresponds to what is obtained by disposing a plurality of (three) power-supply wiring lines Lp1 through Lp3 instead of a single power-supply wiring line Lp in the drive board 13A (see FIG. 6) in Modified Example 1-1 described above, and the rest of the configuration is made basically the same.

Specifically, as shown in FIG. 7, in the drive board 13B, the three power-supply wiring lines Lp1 through Lp3 to which the constant potentials Vv (three types of power-supply potentials Vp1 through Vp3) different from each other are individually applied, and the single ground wiring line Lg each extend along the longitudinal direction (the X-axis direction) of each of the drive devices 41 in the mounting area Am of each of the drive devices 41. Further, in the example shown in FIG. 7, it is arranged that the power-supply potential Vp1 is applied to the power-supply wiring line Lp1, the power-supply potential Vp2 is applied to the power-supply wiring line Lp2, and the power-supply potential Vp3 is applied to the power-supply wiring line Lp3.

Further, in the example shown in FIG. 7, the power-supply terminals Tp at three or more places electrically coupled individually to such a plurality of power-supply wiring lines Lp1 through Lp3, and the ground terminals Tg at three or more places electrically coupled to the ground wiring line Lg are each arranged along the longitudinal direction (the X-axis direction) of each of the drive devices 41. In other words, the power-supply terminals Tp at three or more places and the ground terminals Tg at three or more places are respectively provided to such a plurality of power-supply wiring lines Lp1 through Lp3 and the ground wiring line Lg in substantially the same manner as in Modified Example 1-1 described above.

Here, the plurality of power-supply potentials Vp1 through Vp3 each corresponds to a specific example of a “predetermined constant potential” in the present disclosure. Further, the plurality of power-supply wiring lines Lp1 through Lp3 each corresponds to a specific example of a “constant-potential wiring line” in the present disclosure. Further, also in Modified Example 1-2 described above, similarly to Modified Example 1-1, the power-supply terminals Tp at three or more places described above, and the ground terminals Tg at three or more places each correspond to the “constant-potential terminals at three or more places” in the present disclosure.

### Functions/Advantages

Also in Modified Example 1-2 having such a configuration, it becomes possible to obtain substantially the same advantages due to basically the same functions as those of Modified Example 1-1.

Further, in particular in Modified Example 1-2, the power-supply terminals Tp at three or more places and the ground terminals Tg at three or more places are respectively provided to the plurality of power-supply wiring lines Lp1 through Lp3 and the ground wiring line Lg in the drive board 13B. Thus, the reduction in wiring distance described above and the suppression of the variation in ejection characteristics of the ink 9 are realized also when, for example, the plurality of power-supply wiring lines Lp1 through Lp3 corresponding to the plurality of types of power-supply potentials Vp1 through Vp3 are disposed. As a result, it becomes possible to further more improve the printing quality when performing printing.

### Modified Example 1-3

### (Configuration)

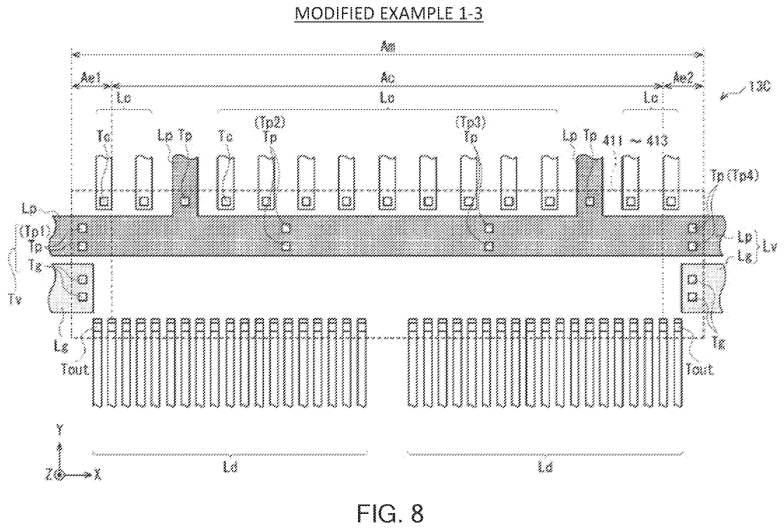

FIG. 8 is a plan view (an X-Y plane view) schematically showing an outline configuration example (a configuration example in the vicinity of each of the drive devices 41) of a drive board (a drive board 13C) related to Modified Example 1-3. The drive board 13C related to Modified Example 1-3 corresponds to what is obtained by changing the arrangement configuration of the ground wiring lines Lg and the ground terminals Tg in the drive board 13A (see FIG. 6) related to Modified Example 1-1 described above, and the rest of the configuration is made basically the same.

Specifically, as shown in FIG. 8, in the drive board 13C, only the power-supply terminals Tp at three or more places are disposed as the constant-potential terminals Tv at three or more places described above unlike the drive board 13A (FIG. 6) in Modified Example 1-1. In contrast, in the example shown in FIG. 8, the ground terminals Tg (two pairs of ground terminals Tg) are electrically coupled to the ground wiring line Lg only in the pair of end portions along the longitudinal direction of each of the drive devices 41. It should be noted that also in the example shown in FIG. 8, similarly to Modified Example 1-2 (FIG. 7) described above, it is possible to arrange that the plurality of power-supply lines Lp1 through Lp3 and so on are disposed instead of the single power-supply wiring line Lp.

Here, in Modified Example 1-3, the power-supply terminals Tp at three or more places described above correspond to a specific example of the “constant-potential terminals at three or more places” in the present disclosure.

### Functions/Advantages

Also in Modified Example 1-3 having such a configuration, it becomes possible to obtain substantially the same advantages due to basically the same functions as those of the first embodiment.

Further, in particular in Modified Example 1-3 described above, since the power-supply terminals Tp at three or more places are disposed as the constant-potential terminals Tv at three or more places described above, the following is arranged. That is, the wiring distance (the wiring distance inside each of the drive devices 41) from each of the constant-potential terminals Tv (the power-supply terminals Tp) to corresponding one of the output terminals Tout shortens. Further, the variation in impedance of the wiring lines (the power-supply wiring lines Lp) between the output terminals Tout is further suppressed, as a result, the variation in the ejection characteristics of the ink 9 from the nozzle holes Hn is further suppressed. As a result, it becomes possible to further improve the printing quality when performing printing.

### 3. Second Embodiment

Then, a second embodiment of the present disclosure will be described. Unlike the first embodiment and Modified Examples 1-1 through 1-3 described hereinabove, the second embodiment corresponds to an example when the drive devices 41 are mounted on the board surface S using the wire-bonding mounting. It should be noted that hereinafter, the same constituents as those in the first embodiment and so on are denoted by the same reference symbols, and the description thereof will appropriately be omitted.

### (Configuration)

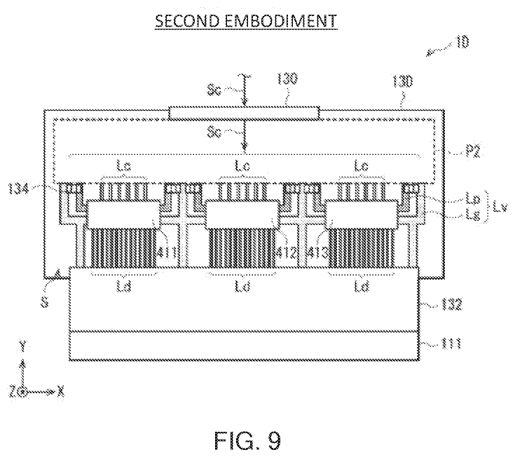

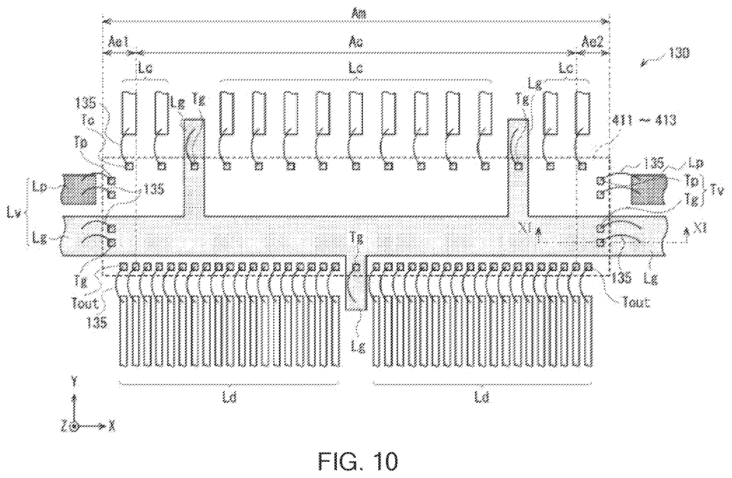

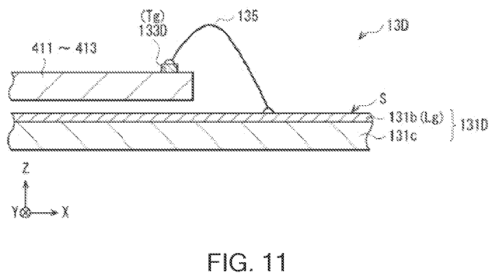

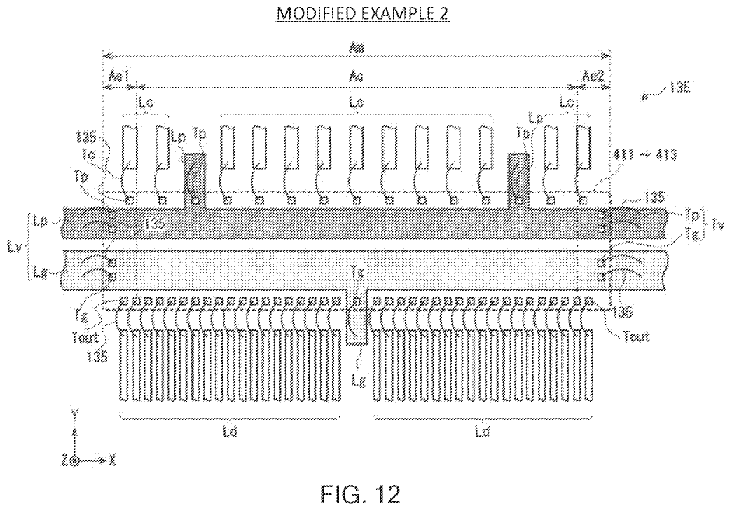

FIG. 9 is a plan view (an X-Y plane view) schematically showing an outline configuration example of a liquid jet head (an inkjet head 1D) according to the second embodiment. It should be noted that in FIG. 9, the illustration of a structure is omitted, and only an electrical circuit, the actuator plate 111, and a relaying flexible board 132 described later are shown. Further, in an area (an area between the connector 130 and the decoupling capacitor 134) denoted by the reference symbol P2 in FIG. 9, the illustration of a variety of wiring lines is omitted for the sake of convenience. FIG. 10 is a plan view (an X-Y plane view) schematically showing an outline configuration example (a configuration example in the vicinity of each of the drive devices 411 through 413) of a drive board 13D shown in FIG. 9. FIG. 11 is a diagram schematically showing a cross-sectional configuration example (a Z-X cross-sectional configuration example) along the line XI-XI shown in FIG. 10. It should be noted that in FIG. 10, the variety of wiring lines located at the reverse surface side (a rigid board 131D side in the example shown in FIG. 10) of each of the drive devices 41 are each represented by solid lines for the sake of convenience, and the drive devices 41 are represented by dotted lines as the outer shapes thereof for the sake of convenience. This point also applies to Modified Example 2 (FIG. 12) described later.

The inkjet head 1D according to the second embodiment corresponds to what is obtained by disposing the drive board 13D instead of the drive board 13 in the inkjet head 1 (see FIG. 2) according to the first embodiment, and the rest of the configuration is made basically the same.

It should be noted that this inkjet head 1D corresponds to a specific example of the “liquid jet head” in the present disclosure.

The drive board 13D corresponds to what is obtained by changing the drive devices 41 so as to be mounted on the board surface S using the wire-bonding mounting and at the same time disposing the rigid board 131D instead of the flexible board 131 described above in the drive board 13 (see FIG. 2 and FIG. 5) as described above, and the rest of the configuration is made basically the same.

Specifically, the drive board 13D is configured using the rigid board 131D in which the wiring layer 131b is arranged on a glass epoxy board 131c as shown in, for example, FIG. 11 unlike the drive board 13 (see FIG. 5). Further, as shown in, for example, FIG. 9 through FIG. 11, in the drive board 13D, unlike the drive board 13, the drive devices 41 (411 through 413) are mounted on the board surface S in the rigid board 131D using the wire-bonding mounting. It should be noted that in the example shown in FIG. 9, the drive board 13D is electrically coupled to the actuator plate 111 via the relaying flexible board 132.

More specifically, as shown in, for example, FIG. 11, in the drive board 13D, bonding pads 133D arranged at an obverse surface side (an opposite side to the rigid board 131D) of each of the drive devices 41 and coupling places on the wiring layer 131b (the board surface S) in the rigid board 131D are electrically coupled to each other via the lead wires 135, respectively.

Further, the example of the drive board 13D shown in FIG. 10 is what is obtained by changing the terminals in each of the drive devices 41 and the terminals in the respective wiring lines so as to electrically be coupled to each other via the bonding pads 133D and the lead wires 135 as described above in the example of the drive board 13 shown in FIG. 4, and the rest of the configuration is made basically the same. Specifically, the plurality of control terminals Tc on each of the drive devices 41 and coupling places on the plurality of control wiring lines Lc are electrically coupled to each other via the lead wires 135 and so on, and the plurality of output terminals Tout on each of the drive devices 41 and coupling places on the plurality of drive wiring lines Ld are electrically coupled to each other via the lead wires 135 and so on. Similarly, the power-supply terminals Tp on each of the drive devices 41 and coupling places on the power-supply wiring lines Lp are electrically coupled to each other via the lead wires 135 and so on, and the ground terminals Tg on each of the drive devices 41 and coupling places on the ground wiring lines Lg are electrically coupled to each other via the lead wires 135 and so on.

Further, also in this drive board 13D, similarly to the drive board 13 (see FIG. 4), the constant-potential terminals Tv (the ground terminals Tg) at three or more places are disposed at respective positions different from each other along the longitudinal direction (the X-axis direction) of each of the drive devices 41. Further, the constant-potential terminals Tv (the ground terminals Tg) at three or more places described above are electrically coupled to the constant-potential wiring lines Lv (the ground wiring lines Lg) to which the same constant potential Vv (the ground potential Vg) is applied. Specifically, in the example shown in FIG. 9, in each of the pair of end-portion areas Ae1, Ae2 and the central area Ac, there are arranged the ground terminals Tg at three or more places described above. It should be noted that in the example shown in FIG. 9, unlike the example shown in FIG. 4, the plurality of ground terminals Tg is not arranged in the central area Ac. This is because, since the drive board 13D shown in FIG. 9 is an example of the wire-bonding mounting, it is difficult to arrange the terminals on each of the drive devices 41 in the internal area (an area inside the outer edge) of each of the drive devices 41.

Here, in the second embodiment, the ground terminals Tg at three or more places described above correspond to a specific example of the “constant-potential terminals at three or more places” in the present disclosure.

### Functions/Advantages

Also in the second embodiment having such a configuration, it becomes possible to obtain substantially the same advantages due to basically the same functions as those of the first embodiment.

### 4. Modified Example of Second Embodiment

Then, a modified example (Modified Example 2) of the second embodiment described above will be described. It should be noted that hereinafter, the same constituents as those in the first or second embodiment or the like are denoted by the same reference symbols, and the description thereof will appropriately be omitted.

### Modified Example 2

### (Configuration)

FIG. 12 is a plan view (an X-Y plane view) schematically showing an outline configuration example (a configuration example in the vicinity of each of the drive devices 41) of a drive board (a drive board 13E) related to Modified Example 2. The drive board 13E related to Modified Example 2 corresponds to what is obtained by changing the arrangement configuration of the power-supply wiring lines Lp and the power-supply terminals Tp in the drive board 13D (see FIG. 10) related to the second embodiment, and the rest of the configuration is made basically the same.

Specifically, as shown in FIG. 12, in the drive board 13E, first, both of the power-supply wiring lines Lp and the ground wiring lines Lg extend along the longitudinal direction (the X-axis direction) of each of the drive devices 41 in the mounting area Am of each of the drive devices 41 similarly to Modified Examples 1-1, 1-2 described above. Further, in the example shown in FIG. 12, both of the power-supply terminals Tp at three or more places electrically coupled to the power-supply wiring line Lp and the ground terminals Tg at three or more places electrically coupled to the ground wiring line Lg are arranged along the longitudinal direction of each of the drive devices 41 similarly to Modified Examples 1-1, 1-2 described above. Specifically, in the example shown in FIG. 12, in each of the pair of end-portion areas Ae1, Ae2 and the central area Ac in the drive board 13E, there are arranged such power-supply terminals Tp at three or more places, and the ground terminals Tg at three or more places.

Here, in Modified Example 2, the power-supply terminals Tp at three or more places described above and the ground terminals Tg at three or more places each correspond to a specific example of the “constant-potential terminals at three or more places” in the present disclosure.

### Functions/Advantages

Also in Modified Example 2 having such a configuration, it becomes possible to obtain substantially the same advantages due to basically the same functions as those of the second embodiment.

Further, in particular in Modified Example 2 described above, since both of the power-supply terminals Tp at three or more places and the ground terminals Tg at three or more places are disposed as the constant-potential terminals Tv at three or more places described above in the drive board 13E similarly to Modified Examples 1-1, 1-2 described above, the following is arranged. That is, the wiring distance (the wiring distance inside each of the drive devices 41) from each of the constant-potential terminals Tv (the power-supply terminals Tp and the ground terminals Tg) to corresponding one of the output terminals Tout shortens. Further, the variation in impedance of the wiring lines (the ground wiring lines Lg and the ground wiring lines Lg) between the output terminals Tout is further suppressed, as a result, the variation in the ejection characteristics of the ink 9 from the nozzle holes Hn is further suppressed. As a result, it becomes possible to further improve the printing quality when performing printing.

It should be noted that also in Modified Example 2 (the case of the wire-bonding mounting), similarly to, for example, Modified Example 1-2 described above, it is possible to arrange that the power-supply terminals Tp at three or more places and the ground terminals Tg at three or more places are respectively provided to the plurality of power-supply wiring lines Lp1 through Lp3 and the ground wiring line Lg.

Further, unlike Modified Example 2, it is possible to arrange that the power-supply terminals Tp at three or more places are disposed as the constant-potential terminals Tv at three or more places described above, and at the same time, the ground terminals Tg are disposed at two or less places also in the case of the wire-bonding mounting similarly to, for example, Modified Example 1-3 described above.

### 5. Other Modified Examples

The present disclosure is described hereinabove citing the embodiments and some modified examples, but the present disclosure is not limited to the embodiments and so on, and a variety of modifications can be adopted.

For example, in the embodiments and so on described above, the description is presented specifically citing the configuration examples (the shape, the arrangement, the coupling configuration, the type, the number, and so on) of the members (the drive devices, the variety of wiring lines, the variety of terminals, and so on) in the printer, the inkjet head, and the drive board. It should be noted that these configuration examples are not limited to the configuration examples described in the embodiments and so on described above, and it is possible to adopt other shapes, arrangement, coupling configurations, types, numbers, and so on.

Specifically, for example, the configuration of the I/F board, the drive board and so on is not limited to what is explained in the embodiments and so on described above, and it is possible to adopt other configurations. Further, in the embodiments and so on described above, the description is presented citing when the single drive board is disposed alone as an example, but two or more drive boards, for example, can be disposed. Further, in the embodiments and so on described above, there is described when the I/F board as a relay board is disposed inside the inkjet head, but this is not a limitation, and it is possible to eliminate such a relay board (the I/F board) from, for example, the inkjet head. In addition, in the embodiments and so on described above, the description is presented citing when the plurality of drive devices is arranged side by side along the longitudinal direction on the board surface as an example, but the example of this case is not a limitation. In other words, it is possible to arrange that, for example, the plurality of drive devices is not arranged side by side along the longitudinal direction described above. Further, in the embodiments and so on described above, the description is presented citing when the plurality of drive devices is mounted on the drive board (the board surface) as an example, the example of this case is not a limitation, and it is possible to arrange that, for example, only a single drive device is mounted on the drive board.

Further, a variety of types of structures can be adopted as the structure of the inkjet head. Specifically, it is possible to adopt, for example, a so-called side-shoot type inkjet head which ejects the ink 9 from a central portion in the extending direction of each of the ejection channels in the actuator plate 111. Alternatively, it is possible to adopt, for example, a so-called edge-shoot type inkjet head for ejecting the ink 9 along the extending direction of each of the ejection channels. Further, the type of the printer is not limited to the type described in the embodiments and so on described above, and it is possible to apply a variety of types such as an MEMS (Micro Electro-Mechanical Systems) type.

Further, for example, it is possible to apply the present disclosure to either of an inkjet head of a circulation type which uses the ink 9 while circulating the ink 9 between the ink tank and the inkjet head, and an inkjet head of a non-circulation type which uses the ink 9 without circulating the ink 9.

Further, the series of processing described in the above embodiments and so on can be arranged to be performed by hardware (a circuit), or can also be arranged to be performed by software (a program). When arranging that the series of processing is performed by the software, the software is constituted by a program group for making the computer perform the functions. The programs can be incorporated in advance in the computer described above to be used by the computer, for example, or can also be installed in the computer described above from a network or a recording medium to be used by the computer.

Further, in the above embodiments and so on, the description is presented citing the printer (the inkjet printer) as a specific example of the “liquid jet recording device” in the present disclosure, but this example is not a limitation, and it is also possible to apply the present disclosure to other devices than the inkjet printer. In other words, it is also possible to arrange that the “liquid jet head” (the inkjet head) of the present disclosure is applied to other devices than the inkjet printer. Specifically, it is also possible to arrange that the “liquid jet head” of the present disclosure is applied to a device such as a facsimile or an on-demand printer.

In addition, it is also possible to apply the variety of examples described hereinabove in arbitrary combination.

It should be noted that the advantages described in the present specification are illustrative only, but are not a limitation, and other advantages can also be provided.

Further, the present disclosure can also take the following configurations.

<1> A drive board configured to output a drive signal to be applied to a liquid jet head having a plurality of nozzles, the drive board comprising at least one drive device which is mounted on a board surface of the drive board, and which is configured to generate the drive signal configured to jet liquid from the nozzles; and at least one constant-potential wiring line which extends along a longitudinal direction of the drive device in a mounting area of the drive device, and to which a predetermined constant potential is applied, wherein the drive device includes a plurality of output terminals which is arranged along the longitudinal direction, and which is configured to individually output the drive signal, and constant-potential terminals at three or more places, which are arranged at respective positions different from each other along the longitudinal direction, and which are electrically coupled to the constant-potential wiring line to which the same constant potential is applied.

<2> The drive board according to <1>, wherein the drive device has a pair of end-portion areas, and a central area located between the pair of end-portion areas along the longitudinal direction, and the constant-potential terminals are arranged in each of the pair of end-portion areas and the central area.

<3> The drive board according to <2>, wherein two or more of the constant-potential terminals are arranged in the central area.

<4> The drive board according to any one of <1> to <3>, wherein the constant-potential terminals at three or more places are evenly arranged along the longitudinal direction of the drive device.

The drive board according to any one of <1> to <4>, wherein the constant-potential wiring line includes at least one power-supply wiring line to which a power-supply potential as the constant potential is applied, and a ground wiring line to which a ground potential as the constant potential i applied, and the drive board includes at least one of power-supply terminals at three or more places as the constant-potential terminals at three or more places electrically coupled to the power-supply wiring line, and ground terminals at three or more places as the constant-potential terminals at three or more places electrically coupled to the ground wiring line.

<6> The drive board according to <5>, wherein the power-supply terminals at three or more places and the ground terminals at three or more places are provided respectively to a plurality of the power-supply wiring lines and the ground wiring line.

<7> The drive board according to any one of <1> to <6>, wherein the drive device is mounted on the board surface using flip-chip mounting.

The drive board according to any one of <1> to <7>, wherein a plurality of the drive devices is arranged side by side along the longitudinal direction on the board surface.

<9> A liquid jet head comprising the drive board according to any one of <1> to <8>; and a jet section which is configured to jet the liquid based on the drive signal output from the drive board, and which has the plurality of nozzles.

<10> A liquid jet recording device comprising the liquid jet head according to <9>.

What is claimed is:

1. A drive board configured to output a drive signal to be applied to a liquid jet head having a plurality of nozzles, the drive board comprising:
at least one drive device which is mounted on a board surface of the drive board, and which is configured to generate the drive signal configured to jet liquid from the nozzles; and
at least one constant-potential wiring line which extends along a longitudinal direction of the drive device in a mounting area of the drive device, and to which a predetermined constant potential is applied, wherein
the drive device includes
a plurality of output terminals which is arranged along the longitudinal direction, and which is configured to individually output the drive signal, and
constant-potential terminals at three or more places, which are arranged at respective positions different from each other along the longitudinal direction, and which are electrically coupled to the constant-potential wiring line to which the same constant potential is applied.

2. The drive board according to claim 1, wherein
the drive device has a pair of end-portion areas, and a central area located between the pair of end-portion areas along the longitudinal direction, and
the constant-potential terminals are arranged in each of the pair of end-portion areas and the central area.

3. The drive board according to claim 2, wherein
two or more of the constant-potential terminals are arranged in the central area.

4. The drive board according to claim 1, wherein
the constant-potential terminals at three or more places are evenly arranged along the longitudinal direction of the drive device.

5. The drive board according to claim 1, wherein
the constant-potential wiring line includes
at least one power-supply wiring line to which a power-supply potential as the constant potential is applied, and
a ground wiring line to which a ground potential as the constant potential is applied, and
the drive board includes at least one of
power-supply terminals at three or more places as the constant-potential terminals at three or more places electrically coupled to the power-supply wiring line, and
ground terminals at three or more places as the constant-potential terminals at three or more places electrically coupled to the ground wiring line.

6. The drive board according to claim 5, wherein
the power-supply terminals at three or more places and the ground terminals at three or more places are provided respectively to a plurality of the power-supply wiring lines and the ground wiring line.

7. The drive board according to claim 1, wherein
the drive device is mounted on the board surface using flip-chip mounting.

8. The drive board according to claim 1, wherein
a plurality of the drive devices is arranged side by side along the longitudinal direction on the board surface.

9. A liquid jet head comprising:
the drive board according to claim 1; and
a jet section which is configured to jet the liquid based on the drive signal output from the drive board, and which has the plurality of nozzles.

10. A liquid jet recording device comprising the liquid jet head according to claim 9.
